(19) United States
(12) Patent Application Publication
(10) Pub. No.: US 2010/0148106 A1
(43) Pub. Date: Jun. 17, 2010

(54) VALVE ASSEMBLY

(76) Inventor: Kevin Whitefield, Norfolk (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/997,183

(22) PCT Filed: Aug. 4, 2006
(86) PCT No.: PCT/GB06/02912

§ 371 Date: Jan. 29, 2008

(30) Foreign Application Priority Data
Aug. 11, 2005 (GB) 0516500.6

(51) Int. Cl. F16K 1/22; F16K 27/02

(52) U.S. Cl. 251/305

(57) ABSTRACT

A valve assembly comprises a housing (1) defining a conduit (2) through which fluid may flow and a butterfly plate (8) rotatably mounted within the housing (1) so as to control the flow of fluid through the housing; the plate incorporating oppositely located projections which extend beyond the conduit; the plate and projections being of one piece and wherein each of the projections extends beyond said conduit into a respective one of two end recesses (9) located in oppositely facing rotatable shafts (7) so that the plate rotates within the housing together with the rotatable shafts; characterised in that the projections are held in place within the recesses, solely by the interfit between the valve components once the valve is assembled for use (e.g. with no screw of other auxiliary clamping means securing the projections to the shafts).

### FIELD OF THE INVENTION

The invention relates to valve assemblies and particularly to valve assemblies incorporating a butterfly plate for controlling the flow of fluid through the valve's housing.

### BACKGROUND TO THE INVENTION AND PRIOR ART KNOWN TO THE APPLICANT

A number of prior art documents were identified which incorporate a butterfly plate with side projections: EP0705967A1 (Hahn, Karlheinz); GB2352018 (PCC Flow Technologies Ltd); US2004/026650A1 (Maraub et al); US2004/187920A1 (Schmidt, Roman et al); DE1083611 (Voith); U.S. Pat. No. 6,446,338B1 (Lei-Jui Wu); EP1380741A1 (Ford Global Technologies Inc; Mullerstroem, Oscar); DE699819; FR815356; and CH185491.

A large number of differences exist between the teaching of these documents and the present invention. One of these differences is that none of these shows projections which extend beyond the conduit into corresponding recesses located in rotatable shafts so that a butterfly plate rotates together with rotatable shafts.

The following prior art documents were also identified: U.S. Pat. No. 5,342,019 (Mtu Motoren Und Turbinen—Union Friedrich Fhafen GmbH; Braun, Hermann et al); GB2270365A (same applicant and inventor as previous citation); FR1516685; GB2402459A (Tomoe Technical Research Company Ltd).

None of the above documents shows a valve assembly with a butterfly plate with projections. In these prior art documents, the plate is either held within the conduit or the plate is sufficiently hollow to receive a rotatable shaft.

The closest piece of prior art identified is CH689517 which relies on the use of screws to secure the butterfly plate to its rotatable shafts. One of the problems with this closest piece of prior art is that its butterfly plate is particularly difficult to assemble and disassemble.

### SUMMARY OF THE INVENTION

In a first broad independent aspect, the invention provides a valve assembly, comprising a housing defining a conduit through which a fluid may flow and a butterfly plate rotatably mounted within said housing so as to control the flow of fluid through said housing; said plate incorporating oppositely located projections which extend beyond the conduit; said plate and projections being of one piece and wherein each of said projections extends beyond said conduit into a respective one of two end recesses located in oppositely facing rotatable shafts so that the plate rotates within the housing together with said rotatable shafts; characterised in that the projections are held in place within said recesses, solely by the interfit between the valve components once the valve is assembled for use (e.g. with no screw or other auxiliary clamping means securing the projections to the shafts).

In this configuration, the butterfly plate may be readily made to slot into the rotatable shafts. This configuration will also have the advantages of minimising the area occupied by the butterfly plate in the conduit so that higher maximum air flow may be achieved than the prior art in a given conduit size. This will also have the consequence of achieving higher maximum power output if the valve assembly is used in the inlet manifold of an internal combustion engine without using a larger conduit. This will also allow the butterfly plate to cause minimum turbulence from mid to full throttle openings which would eliminate premature topping out of the airflow at less than full throttle opening so that a higher maximum airflow may be achieved.

This configuration will also allow any premature pressure wave reflection caused by the throttle to be diluted in order to minimise this detrimental effect on a tuned length conduit, thus improving the air ram effect into the combustion chamber of an internal combustion engine and increasing maximum power. This combination of features would also allow a valve assembly to be used in a wider range of engine sizes in order to satisfy the demands of both road and race vehicles. It will also particularly allow a relatively straightforward modular assembly. Other advantages may be apparent when such valve assemblies are used in an array in a common housing or individual housings for multi-cylinder engines.

In a subsidiary aspect in accordance with the invention's first broad independent aspect, the valve assembly comprises annular members located around the projections and a portion of said rotatable shafts. This would allow the plate to be secured to rotatable shafts without requiring any screw mechanism. This configuration will therefore facilitate modular assembly of the valve.

In a further subsidiary aspect, at least one of said recesses incorporates at least one side opening allowing the insertion and/or removal of a plate projection.

In a further subsidiary aspect, channels are provided extending from the mounting locations of the plate to outermost portions of said housing along the inside of the conduit. This would allow the plate to be inserted through its conduit which would avoid having to form the housing from two halves which separate substantially about the axis of rotation of the plate.

In a further subsidiary aspect, inserts are provided which are sized and shaped to fill in said channels. This configuration will allow the conduit to have a substantially complete and smooth main bore which would avoid introducing unnecessary turbulence within the conduit.

In a further subsidiary aspect, said channels extend in the upstream side of the valve assembly. This is a particularly advantageous form of valve assembly when used in an air intake for an internal combustion engine as it will be less sensitive to air leaks.

In a further subsidiary aspect, said butterfly plate is formed of two D-shaped half plates, each with diametrically opposite projections which extend beyond the conduit into corresponding recesses located in rotatable shafts. This will have particular applications when the conduit is ovalised. This will have particular applications in Siamese inlet ports in the cylinder heads, as it would minimise the change in cross-sectional shape along the length of the inlet track and improve flow efficiency.

In a further subsidiary aspect, said two D-shaped half plates are operatively connected through a gear. This would have particular advantages when set up to achieve counter-rotation of the plates.

In a second broad independent aspect, the invention provides a valve assembly comprising: a housing defining a conduit through which a fluid may flow; and a butterfly plate rotatably mounted to said housing so as to control the flow of fluid through said housing; said plate incorporating oppositely located projections which extend beyond the conduit; characterised in that the housing is formed of at least two separate components so that, when said at least two separable components are separated, the plate may be removed from said housing. This configuration would also achieve many of the advantages detailed with regard to the first broad independent aspect above. It will, in particular, improve the assembly of the valve whilst achieving improved flow capabilities.

In a further subsidiary aspect, the projections are rectangular in cross-section. In this configuration, an interlock may be achieved between the projections and the rotatable shaft these engage with. Thus, this configuration would achieve secure mounting as if the projections were screwed to the rotatable shafts without requiring them to be.

In a further subsidiary aspect, sealing means are provided between the separable components of the second broad independent aspect. This would prevent air or any other fluid from escaping the conduit through any gap between the separable components.

In a further subsidiary aspect, the plate is tapered from a region about its axis rotation towards a peripheral region. This configuration will optimise the strength of the component in use whilst minimising its disturbance of the flow through the conduit.

In a further subsidiary aspect, a further projection extends from said projection in order to interfit with a corresponding recess in said rotatable shaft. This avoids the need to use a collar, bearing or other surrounding device.

### BRIEF DESCRIPTION OF THE FIGURES

FIG. 1 shows a perspective view of a valve assembly in accordance with a first embodiment of the invention.

FIG. 2 shows an end view of said first embodiment of the invention which includes the definition of Section AA.

FIG. 3 shows Section AA with direction of airflow F and the valve assembly in a closed, part open and fully open configuration.

FIG. 4 shows an exploded view of the assembly.

FIG. 5 shows an exploded view of the assembly in a second embodiment of the invention.

FIG. 6 shows a general cross section through the assembly in accordance with either of the embodiments.

FIG. 7 shows the throttle shaft assembly partially exploded.

FIG. 8 shows an exploded view of the twin throttle plate version of the assembly.

FIG. 9 shows a general cross section through the twin throttle plate version.

FIG. 10 shows a horizontal cross section through the twin throttle plate version with direction of airflow F and the throttle in a closed, part open and fully open position.

FIG. 11 shows a perspective view of a throttle with oppositely located projections, each having an additional radially extending projection 15 preventing the throttle to displace laterally once engaged in the stub-shaft corresponding receiving recess 16. No collar is required for this interfit to function.

FIG. 12 shows a perspective view of a twin throttle arrangement.

FIG. 13 shows a perspective view of a part of a further throttle arrangement in accordance with a further embodiment.

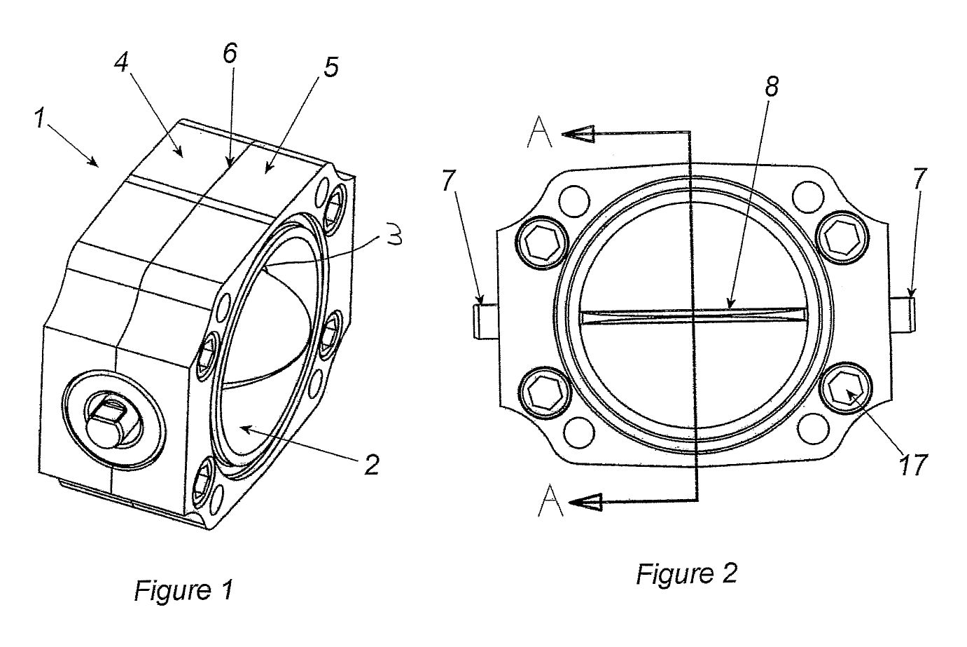

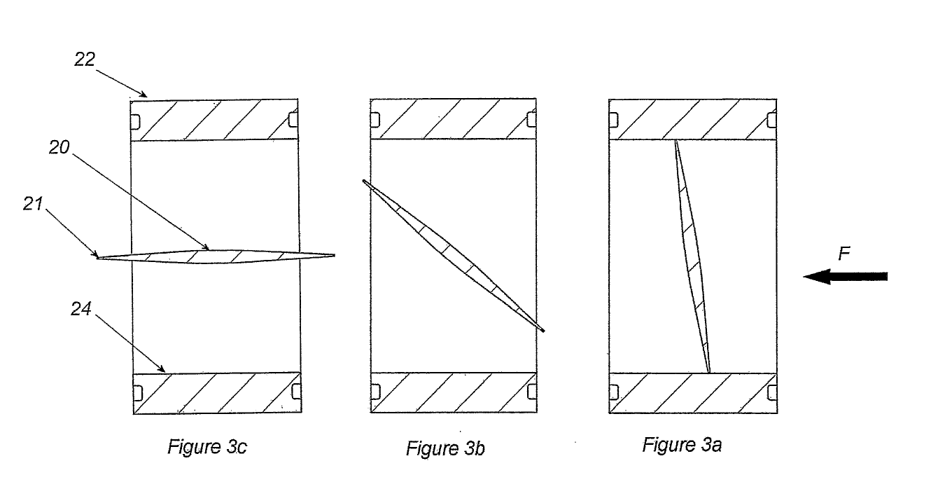

### DETAILED DESCRIPTION OF THE FIGURES

The valve assembly takes the form of a butterfly throttle body assembly without either a shaft traversing the plate or screws attaching plate projections to rotatable shafts.

By way of example a housing 1 has a conventional circular main bore 2 which forms a conduit allowing the passage of a fluid such as air and holes such as hole 3 perpendicular to the direction of flow for receiving rotatable shaft portions 7. The housing is split into two parts 4 and 5 with the joint line 6 on the shaft hole axis and at any angle but in this example perpendicular to the main bore 2. The two oppositely located shaft portions 7 effectively form a shaft split into two parts without a middle section in the main bore area. These are effectively stub shafts 7 to act as co-linear rotational pivots for the throttle butterfly plate 8. A slot 9 (see FIG. 5) is cut into the inner ends of both stub shafts acting as a recess with one or more side openings allowing the insertion of the plate projections or tangs 11. The outer ends of the stub shafts are D-shaped or other non-circular form to conventionally be driven by a throttle linkage or to drive a throttle position sensor.

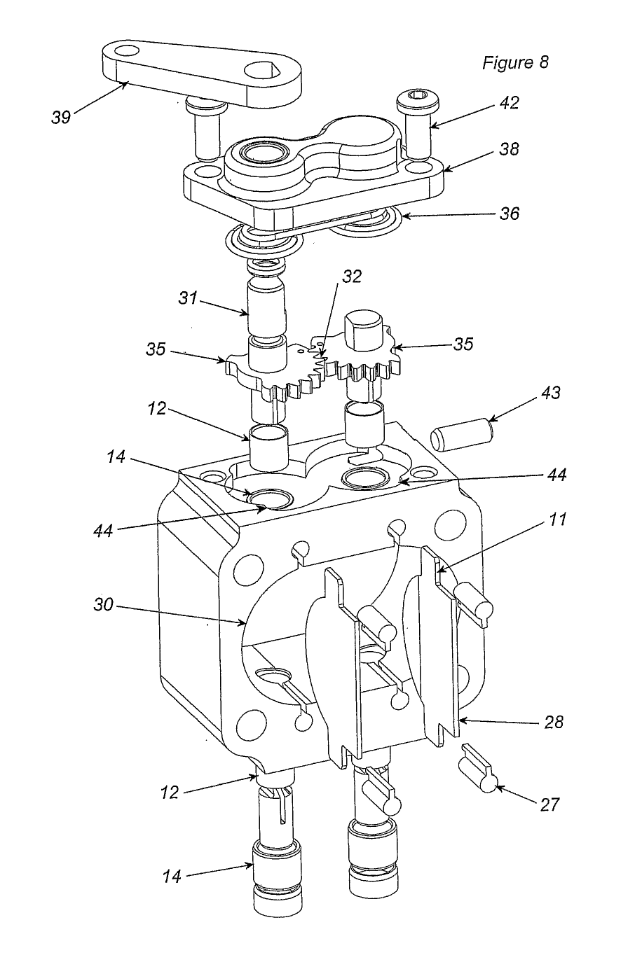

The throttle plate has a slightly oval profile with rectangular tangs 11 projecting from both sides that accurately locate in the slots 9 of the respective stub shafts. The width of the rectangular tangs 11 is equal to the diameter of the stub shafts. A collar 12′ is located on the outside of each stub shaft to accurately locate the tangs 11. This collar may be the internal ring of a ball or roller bearing 13, or it may simply rotate directly in the housing or a plain bearing 14 (see FIG. 8).

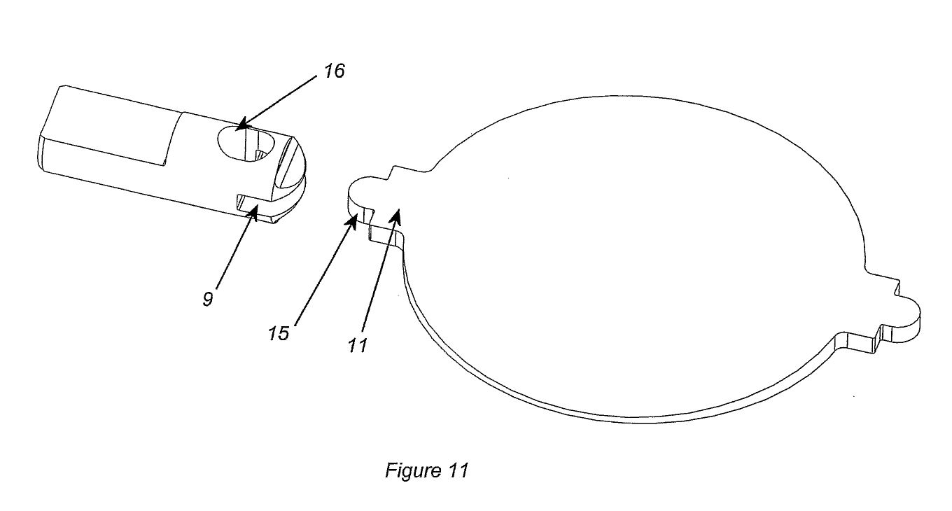

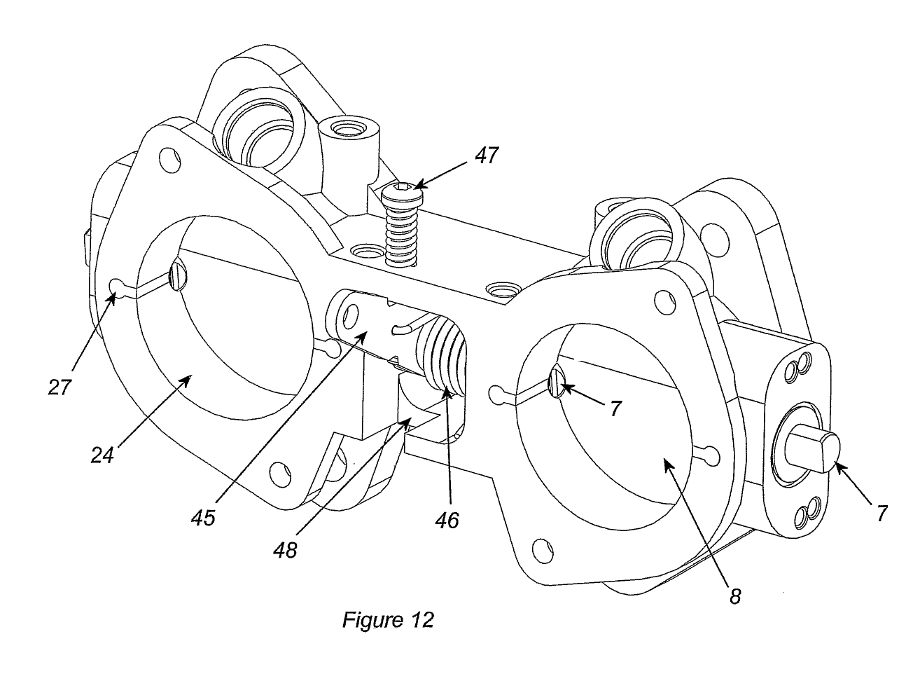

Instead of a collar, the tangs 11 may have an additional smaller tang 15 that locates in a hole 16 in the stub shafts (FIG. 11).

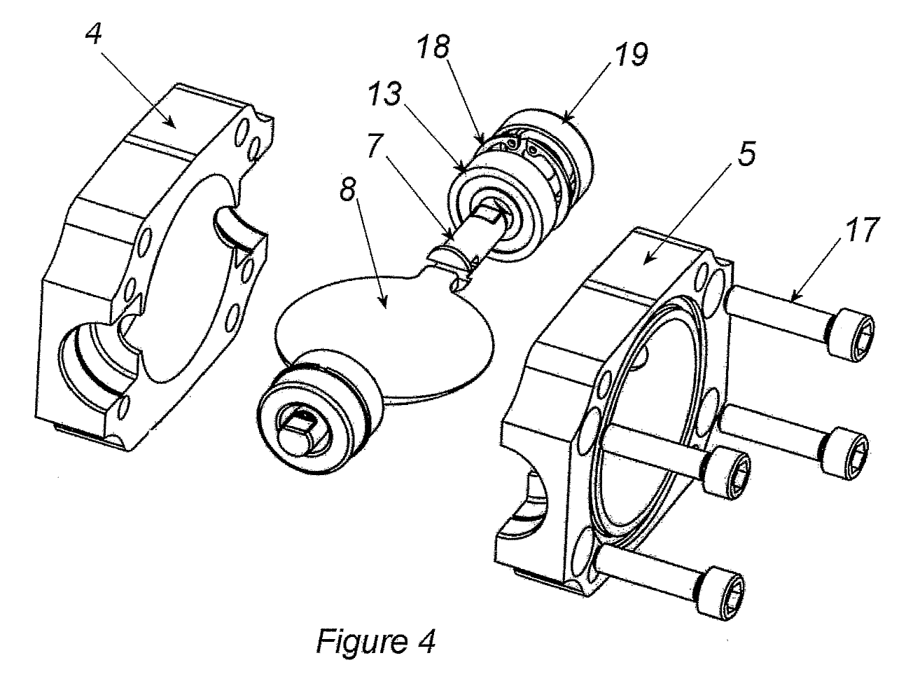

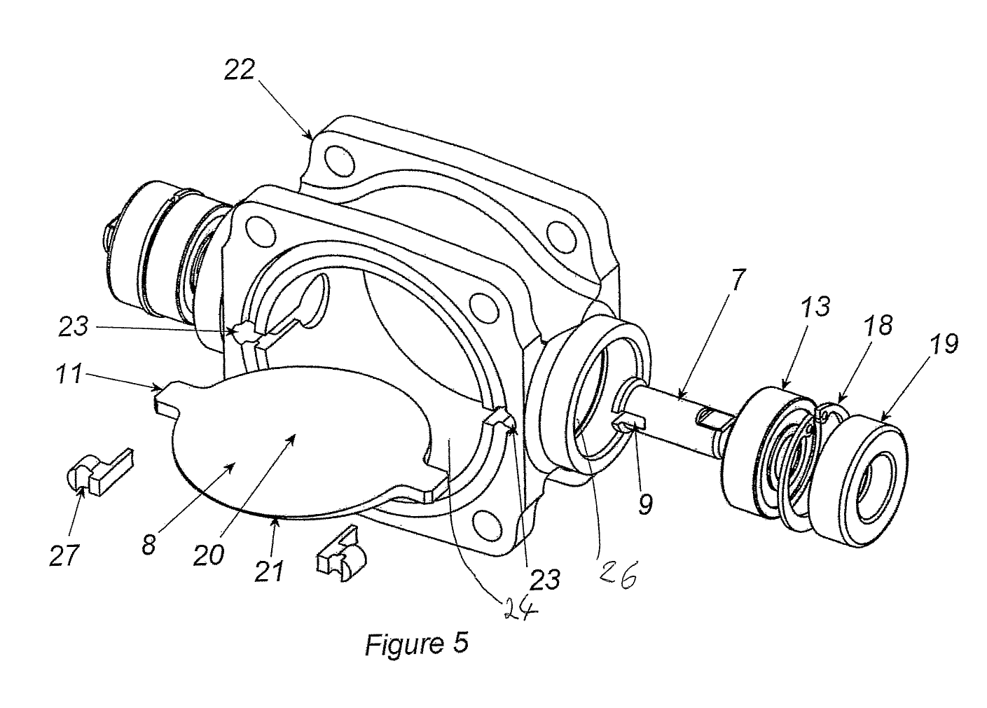

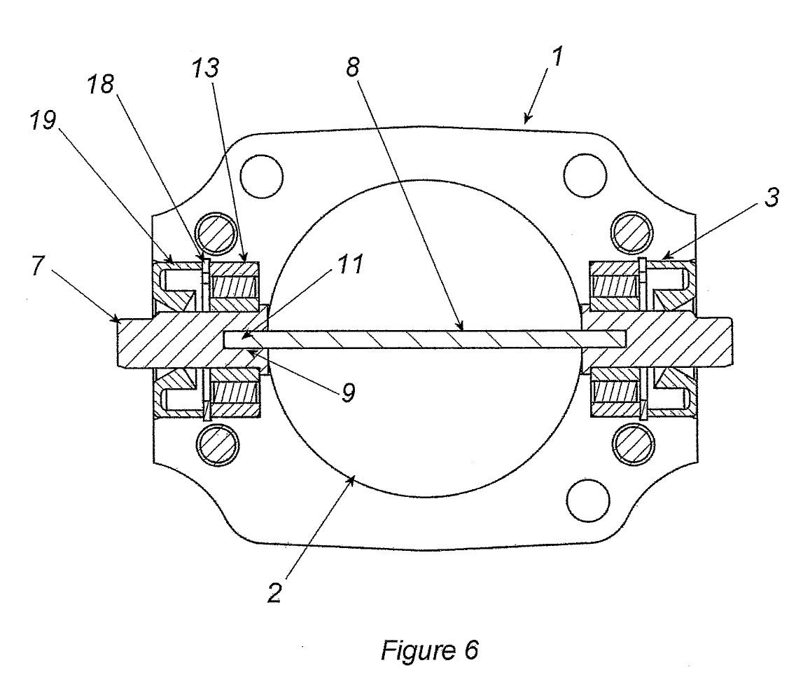

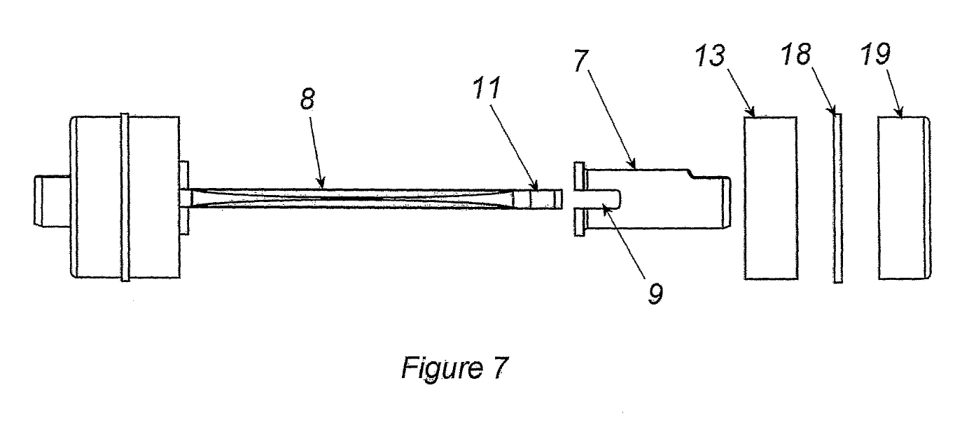

Alternatively the stub shafts 7 and throttle plate 8 may be made from one piece, eliminating the need for the collars 12. Thus the order of assembly is such that the shaft/throttle assembly is assembled into one part of the housing 4, and then the second part of the housing 5 is assembled thus trapping the shaft/throttle assembly into place. Bolts 17 (FIG. 4) are used to clamp the housing parts 4 and 5 together with a sealant between the mating faces to prevent air leakage. Bearings 13, circlips 18 and seals 19 are pressed in place axially on the stub shafts after the housing is clamped together. Alternatively the bearings 13 and/or seals 19 can be pre-assembled to be part of the shaft/throttle assembly, the bearing being retained by adhesive or an integral collar machined in the housing. The action of rotating open the throttle against a return spring is conventional.

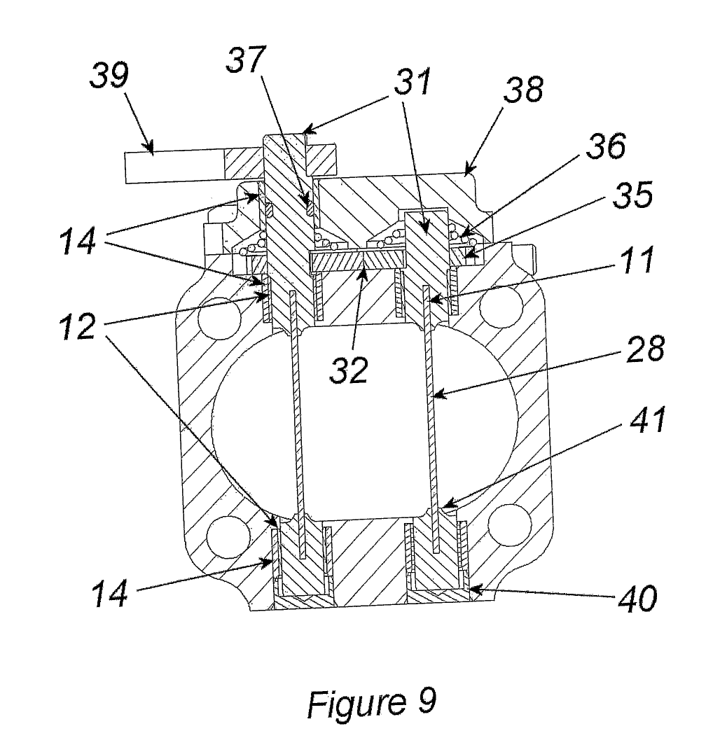

The throttle plate 8 is just thick, strong and stiff enough to prevent excessive deflection due to pressure loading while in use. The throttle plate may be of uniform thickness or its section may be thicker in the middle 20 than at the edges 21 to resist any bending while providing an aerodynamically efficient profile. The edges 21 may be sharp, have a flat or radius or combination of these. The tangs 11 may be thicker than the main area of the throttle plate to increase strength where they join the oval outline. The inner ends of the shafts may be flat or have a small extension 41 (FIG. 9) to help spread load from the shaft into the throttle plate.

An alternative embodiment to the split housing 4 and 5 is to make the housing in one piece 22 (FIG. 5). Keyhole shaped slots 23 are cut in the housing 22 both sides and parallel to the main bore 24 from the front-end face to the throttle spindle bore 26. The throttle plate 8 is inserted down the keyhole shaped slots 23 then the stub shafts 7, bearings 13 and seals 18 are assembled from the sides. The keyway shaped slots 23 forms a channel which may then be filled with matching extruded or moulded sections 27 to leave a complete and smooth main bore 24. It is preferable for the slots 23 to be on the upstream side of the throttle as this is less sensitive to air leaks.

A further embodiment of the invention is envisaged when the valve assembly is used with ovalised main bores. Ovalised bores are usually used to match more closely the shape of the siamese inlet ports in the cylinder head, so minimising any change in cross-sectional shape along the length of the inlet tract and improving flow efficiency. Conventionally, the throttle plate rotates on a horizontal axis across the long chord of the ovalised bore. This provides equal flow to both sides of the siamese ports. Unfortunately, the longer length of throttle plate between its supports at each end requires it to be relatively thick to prevent excessive bending due to the pressure loading. If the throttle plate rotated on a vertical axis across the short chord of the ovalised bore then airflow would detrimentally favour one side of the siamese port until frill throttle is achieved.

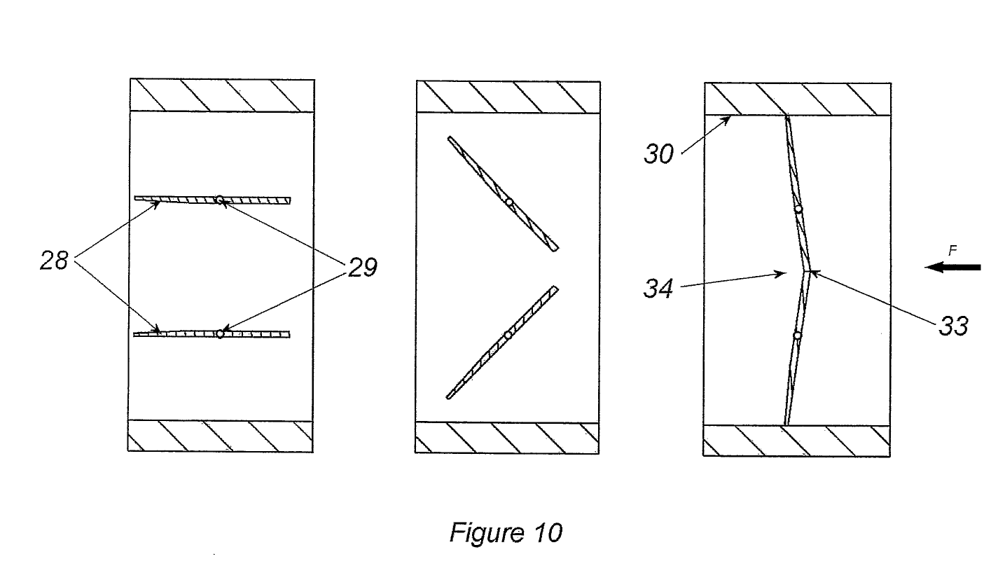

The low restriction to flow provided by this invention would allow twin throttle plates 28 rotating on parallel axis 29 (FIG. 10) across the short chord of the ovalised bore 30. The twin plates each have a mirrored ‘D’ shape profile with the rotational axis 29 approximately inline with the centre of area of each plate. The shafts 31 (FIG. 9) are directly geared together 32 using gears 35 causing the plates 28 to counter-rotate. An integral spring 36 rotationally acts on the gears 35 to close the throttle while the actuating lever 39 may be used to open the throttle against the force of the spring 36. The spring 36 may be a combined unit or individual to each shaft. Screw 43 (FIG. 8) is located in the housing and acts on one gear 35 to set the throttle to a slightly open position thus setting the engine idle speed. The housing incorporates a throttle stop position 44 which acts on the gears 35 in the fully open position to stop them opening too far and jamming. The mechanism is protected by cover 38 which is held in place by screws 42. A shaft 31 projects through the cover 38 to engage the actuating lever 39. An o-ring seal 37 (FIG. 9) prevents dirt and air entering the throttle assembly. Plugs 40 prevent dirt and air entering from underneath.

The profile of the throttle plates 28 must accurately match the housing bore and the vertical edge of each plate 33 must accurately butt together or overlap to prevent flow when the throttle is closed. When closed together to a stop the plates form a very wide-angle ‘V’ section 34 (FIG. 10), blocking the airflow. As there are twin plates the flow to each side of the siamese ports is balanced. As the throttle plates 28 are shorter they can be thinner, thus minimising any flow restriction. Also as there are two throttle plates each one is less wide so will cause even less turbulence at part throttle, making them more flow efficiently at all throttle openings.

The housing may be of a single bore type or have twin bores with each having their own butterfly plate. In this latest configuration, the two butterfly plates may be operatively connected to an actuating lever 45 (FIG. 12) operating between the plates rather than on one outermost side of the twin housing as in the prior art. This would reduce the requirement for plate toughness allowing thinner plates to be employed as in the prior art. A spring 46 may act on the lever 45 to close the throttle. A throttle stop screw 47 may act on the lever 45 to control the closed position of the throttle plates and a seat 48 on the housing may act on the lever 45 to control the fully open position of the throttle plate.

Furthermore traditionally, plates were made of brass for use in an aluminium housing. By contrast, it is envisaged the option of using a blade of stainless steel with a high silicon aluminium housing. The high silicon content would be 11 to 20% in weight. The stainless steel blade may be preferably an austeritic stainless steel. This would allow stronger and stiffer throttles to be achieved than in the prior art. In addition, the high silicon aluminium would suffer reduced wear which would allow the shaft to be directly interfitted to the housing.

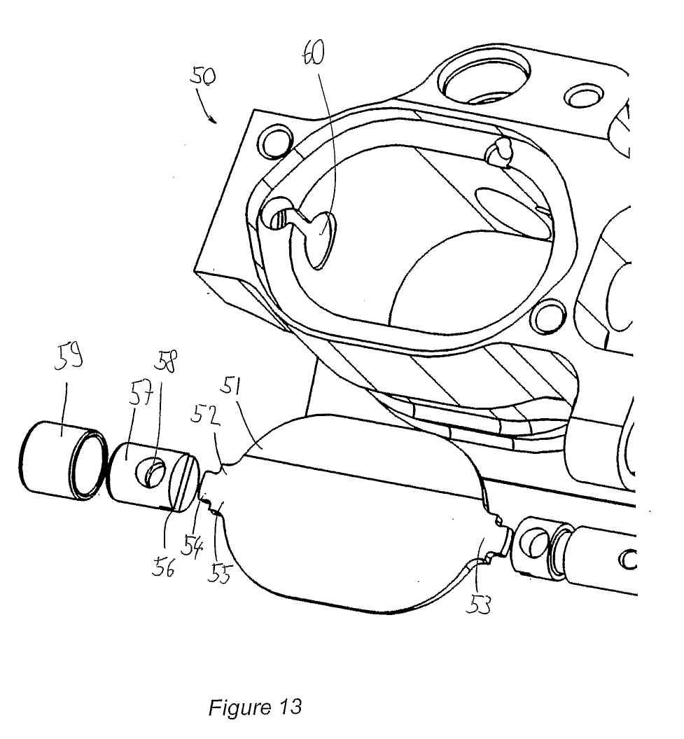

FIG. 13 shows a further embodiment of a housing 50 for a receiving a throttle blade 51. The shape of the throttle blade of this embodiment is a stretched ovoid shape with projections 52 and 53 which are integral with the blade and which extend from the larger diameter of the blade. Each projection incorporates two successive tangs; the outer most tangs being approximately half the width of the inner most tangs. The larger tang 55 is sized and shaped to fit into a slot 56 provided in the stub shaft 57 whilst the smaller tang 54 is sized and shaped to fit into recess 58. The profile of smaller tang 54 comprises a relatively large diameter when compared to the diameter of tang 15 of FIG. 11. A bearing 59 is illustrated which serves to support the stub shaft.

The housing 50 incorporates a single key hole 60 located in the inner wall of the housing allowing the blade to be inserted into the duct and held in place by an interfit of valve components as the projections are held in slots provided in the stub shafts.

1-14. (canceled)

15. A valve assembly, comprising a housing defining a conduit through which a fluid may flow and a butterfly plate rotatably mounted within said housing so as to control the flow of fluid through said housing; said plate incorporating oppositely located projections which extend beyond the conduit; said plate and projections being of one piece and wherein each of said projections extends beyond said conduit into a respective one of two end recesses located in oppositely facing rotatable shafts so that the plate rotates within the housing together with said rotatable shafts; characterised in that the projections are held in place within said recesses, solely by the interfit between the valve components once the valve is assembled for use (e.g. with no screw or other auxiliary clamping means securing the projections to the shafts).

16. A valve assembly according to claim 15, with annular members located around the projections and a portion of said rotatable shafts.

17. A valve assembly according to claim 15, wherein at least one of said recesses incorporates at least one side opening allowing the insertion and/or removal of a plate projection.

18. A valve assembly according to claim 15, wherein channels are provided extending from the mounting locations of the plate to outermost portions of said housing along the inside of the conduit.

19. A valve assembly according to claim 18, wherein inserts are provided which are sized and shaped to fill in said channels.

20. A valve assembly according to claim 19, wherein said channels extend in the upstream side of the valve assembly.

21. A valve assembly, comprising a housing defining a conduit through which a fluid may flow; and a butterfly plate rotatably mounted to said housing so as to control the flow of fluid through said housing; said plate incorporating oppositely located projections which extend beyond the conduit; characterised in that the housing is formed of at least two separable components so that when said at least two separable components arc separated the plate may be removed from said housing.

22. A valve assembly according to claim 15, wherein the plate is tapered from a region about its axis of rotation towards a peripheral region.

23. A valve assembly according to claim 15, wherein a further projection extends from said projection in order to interfit with a corresponding recess in said rotatable shaft.

24. A valve assembly, comprising a housing defining a conduit through which a fluid may flow and a butterfly plate rotatably mounted within said housing so as to control the flow of fluid through said housing; said plate incorporating oppositely located projections each of which extends beyond the conduit and engages at a mounting location within the housing, so that the plate rotates within the housing; characterised by a slot extending from a said mounting location, along an inner housing surface defining the conduit to an outer housing surface, the said slot allowing a corresponding said projection to be inserted into its mounting location during assembly.

25. A valve assembly according to claim 24 comprising an insert of a size and shape to fit the channel.
